(19) United States
(12) Patent Application Publication
(10) Pub. No.: US 2008/0076089 A1
(43) Pub. Date: Mar. 27, 2008

(54) Non-metallic dental scaler

(76) Inventor: Kevin Vu, San Jose, CA (US)

Correspondence Address: EDWIN TARVER, 16830 Ventura Blvd., SUITE 360, Encino, CA, 91436, US

(21) Appl. No.: 11/526,887

(22) Filed: Sep. 21, 2006

(51) Int. Cl. A61C 17/00

(52) U.S. Cl. 433/143

(57) ABSTRACT

A disposable, double-ended, non-metallic dental scaler for personal use made of plastic, resin or another resilient material, comprising a handle and two dental picks projecting axially from either end of the handle. The dental pick includes a stem and an intermediate section projecting from the stem, terminating in a tapered tip. The tips are resilient and softer than conventional metallic tips used by professional dental practitioners. The two tips on the either ends of the handle are equally and oppositely angled with respect to the intermediate sections connected thereto. Due to this angled construction, one of the tips is used for cleaning on the right side of inter-proximal spaces between adjacent teeth while the other tip on the opposite end of the handle is used for cleaning on the left side of inter-proximal spaces.

### CROSS-REFERENCE TO RELATED APPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to dental hygiene devices, more particularly to a dental scaler, and more particularly to a non-metallic double-ended dental scaler that is disposable and safe enough for personal use.

Dentists frequently use scalers in the process of removing plaque and other debris from teeth and in particular, the inter-proximal spaces between teeth. Scalers used in professional dentistry are metallic, and can damage the tooth surface. For this reason, scalers currently known in the art are only used by dental professionals.

Several dental hygiene devices have been developed in art. For example, U.S. Pat. No. 6,247,477 to Wagner discloses a multifunction dental appliance, which includes a cylindrical barrel and a cylindrical carrier plug having a dedicated dental implement, such as a pick or scaler, fitted at one end of the barrel. The other end of the carrier includes a universal affixment post for a further dental implement which is selected from a variety of attachments such as an interdental stimulator, a toothbrush head, a burnishing head, an abrasive stain removing head, a prophy cup, and an interproximal brush. Optionally, both ends of the barrel are open and a carrier is inserted in each end such that two dental implements are available at the same time, without removal of the carriers or attachments.

U.S. Pat. No. 4,326,548 to Wagner discloses a dental tool for personal oral hygiene, which includes a pen barrel shaped holder carrying a curved metal pick. The pick includes an arcuate zone ending at a tapered tip. Opposite the tip, the pick includes a stem which is seated in the holder. The pick is formed of a stainless resilient metal alloy having a diameter in the order of one millimeter. The arcuate zone is employed to dislodge food or debris from pockets or interproximal spaces at both the mesial and distal areas of the oral cavity with the tip functioning as a probe. The convex surface of the arcuate zone is employed as a burnishing implement for the removal of soft plaque. However, the above two Wagner's devices are different from the present invention, which concentrates on providing safety and ease for personal usage by suitably designing and employing resilient materials such as plastic for the tips of the dental scaler.

U.S. Pub. No. 20050244788 to Feine discloses a method for supplying dental practitioners with single-use plastic tips for use with an insert for a hand piece in an ultrasonic dental scaler. The single-use tip is employed for maintenance and preventive care for patients with titanium and other dental implants. The tip is packaged individually and sterilized by gas or irradiation, only to be removed after purchase, such as by the dental professional just before use on a patient. Upon completion of the patient care, the tips are preferably discarded. Although this system employs plastic tips, they are to be used by a dental practitioner as opposed to the present invention, which is much softer and therefore safer for personal use.

Since dental scalers with metallic tips are not safe for personal use due to the risk of damaging the teeth, it is an object of the present invention to provide a non-metallic double-ended dental scaler specially designed for safe personal use by employing soft and resilient tips.

A further object is to provide a double-ended dental scaler that is cheaper to produce.

A further object is to provide a double-ended dental scaler that is easy to use and efficient in cleaning inter-proximal spaces between the teeth.

Finally, it is an object of the present invention to provide a double-ended dental scaler that is more convenient to use than a dental floss in removing debris from teeth. These and other objects of the present invention will become better understood with reference to the appended Summary, Description, and Claims.

### SUMMARY

The present invention relates in general to dental hygiene devices, and more particularly to a disposable, double-ended, non-metallic dental scaler that is specially designed for personal use. The dental scaler is made of plastic and comprises a handle and two dental picks projecting axially from either end of the handle. The dental picks comprise a stem connected to the end of the handle and an intermediate section terminating in a tip. The tips are resilient, softer and therefore safer to use, in contrast to the tips of conventional metallic scalers used by dental practitioners.

The two tips on either ends of the handle are equally and oppositely angled with respect to the intermediate sections to which they are connected. Therefore, one of the angled tips will allow for use on the right side of inter-proximal spaces between adjacent teeth, while the other oppositely angled tip on the opposite end of the handle will allow for use on the left side of inter-proximal spaces. The intermediate section can comprise different designs such as an arced structure, a combination of substantially linear segments, or other structures typical of metallic dental scalers known in the art.

### BRIEF DESCRIPTION OF THE FIGURES

FIGS. 1 through 4 are different views of a first embodiment of the dental scaler in accordance with the present invention.

FIGS. 5 through 8 are different views of a second embodiment of the dental scaler in accordance with the present invention.

FIGS. 9 through 12 are different views of a third embodiment of the dental scaler in accordance with the present invention.

### FIGURES—REFERENCE NUMERALS

10 . . . Dental Scaler
11 . . . Handle
12 . . . Dental Pick
13 . . . Stem
14 . . . First Linear Segment
15 . . . Second Linear Segment
16 . . . Tip
17 . . . Alternate Embodiment of the Dental Scaler
18 . . . Dental Pick of the Alternate Embodiment
19 . . . Arced Zone
20 . . . Tip of the Alternate Embodiment

### DETAILED DESCRIPTION

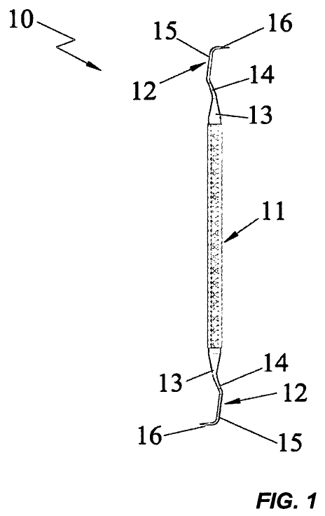

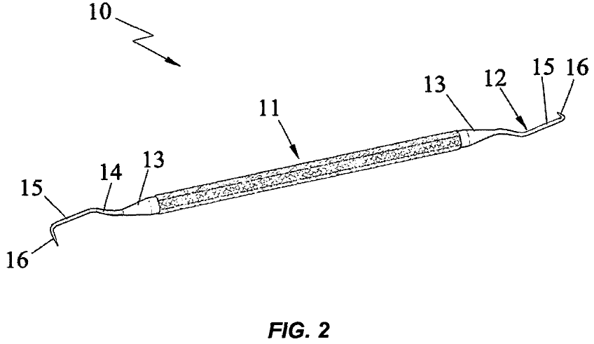

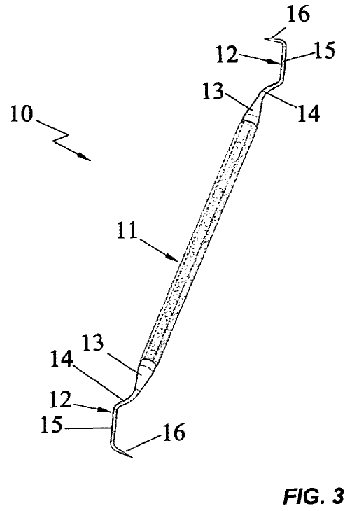

Referring to the drawings, the preferred embodiment of a double-ended dental scaler is illustrated and generally indicated as 10 in FIGS. 1 through 5. The dental scaler 10 is especially designed for safe personal use. The dental scaler 10 is made is made of a non-metallic material such as plastic, and is cheaper to produce compared to conventional stainless steel or metallic dental scalers.

Referring to FIGS. 1 through 4, the dental scaler 10 of the present invention comprises a handle 11 and two dental picks 12 projecting axially from either end of the handle 11. The dental picks 12 include a stem 13 connected to the end of the handle 11, a first substantially linear segment 14 projecting at an angle from the stem, a second substantially linear segment 15 projecting at an angle from the first linear segment 14 and a tip 16 projecting at an angle from the second linear segment 15. Being made of plastic resin, or another similar non-metallic material, the tips 16 are resilient, softer, and safer than conventional metallic picks used by dental practitioners, making the dental scaler 10 suitable for personal use.

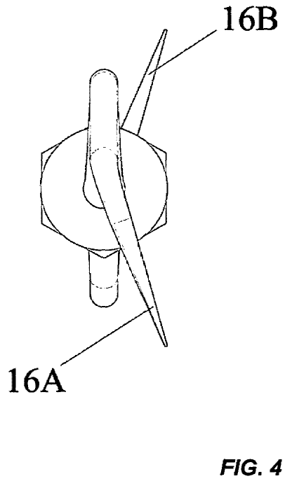

The two tips, first 16A and second 16B, on either end of the handle are in different planes, as shown in FIG. 4. The first tip 16A and the second tip 16B are equally and oppositely angled with respect to the second linear segments 15. The first tip 16A on one end of the handle is angled for use on the right side of the inter-proximal spaces between adjacent teeth, while the second tip 16B is angled for use on the left side of inter-proximal spaces between adjacent teeth. This design of the tips makes the dental scaler 10 more convenient and efficient for cleaning inter-proximal spaces.

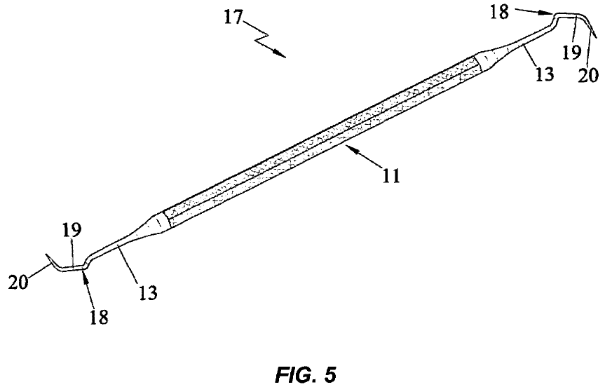

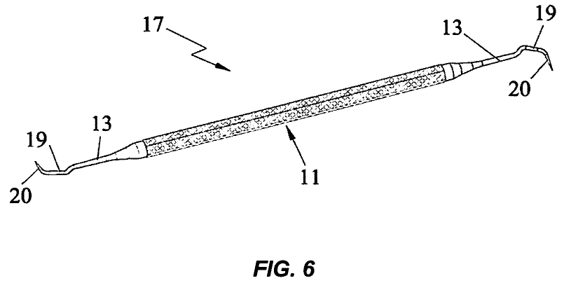

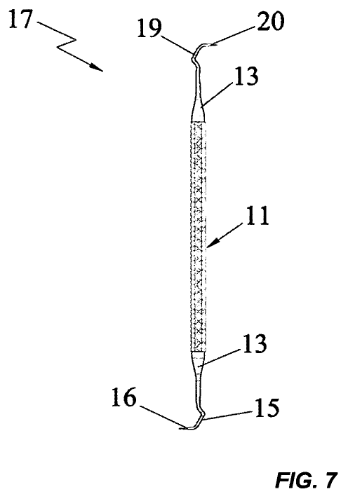

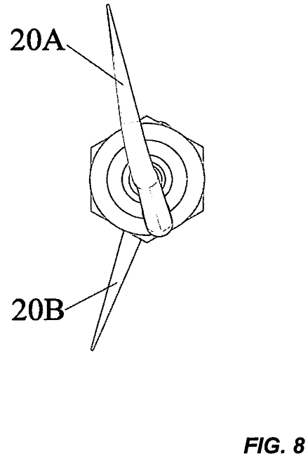

Referring to FIGS. 5 through 8, an alternate embodiment of the dental scaler 17 is illustrated. In this embodiment, the scaler 17 is also double-ended and made of a non-metallic material such as plastic or resin. The dental pick 18 includes a stem 13, an arced zone 19 projecting from the stem 13, and a tip 20 projecting at an angle from the arced zone 19. The tips 20 are resilient, softer, and safer than conventional metallic picks. Similar to the previous embodiment 10, the two tips, first 20A and second 20B, on either end of the handle 11 are in different planes and are equally and oppositely angled with respect to the arced zones 19 connected thereto, as seen in FIG. 8. The first and second tips are angled to allow for use on the right and left side of the inter-proximal spaces between teeth, respectively.

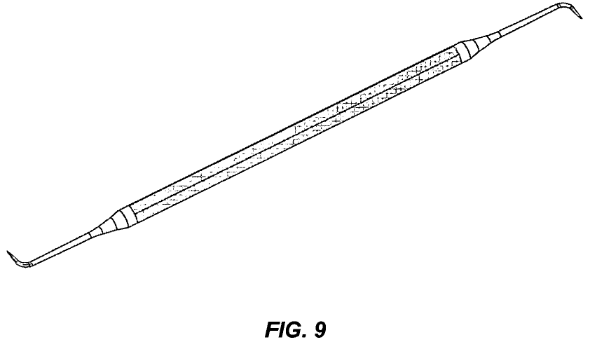

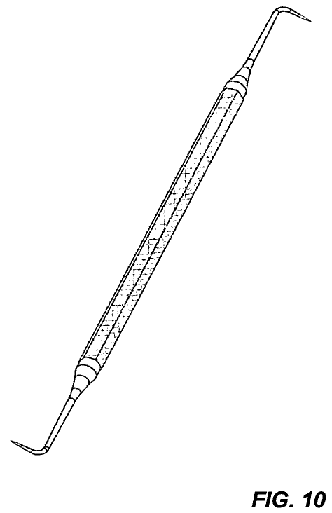

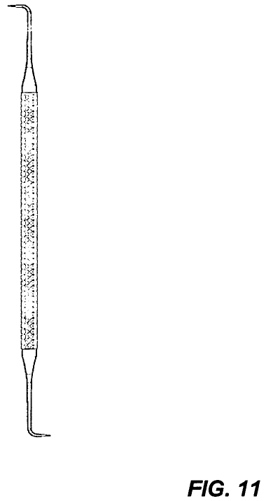

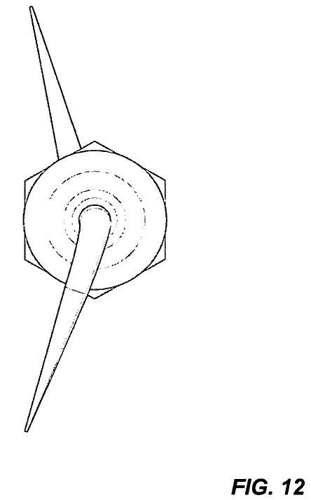

FIGS. 9 through 12 show an alternate embodiment of the invention. The criterion for this and all other alternate embodiments is that the two tips on either end of the handle are resilient, softer, and equally and oppositely angled to allow for use on both the right and left side of inter-proximal spaces between teeth. The two linear segments and the arced zone may be replaced in alternate embodiments with any other structure that is typically used in metallic dental scalers. The plastic dental scalers of the present invention are disposable unlike metallic scalers, which are relatively expensive and must be sterilized prior to re-use.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. § 112, paragraph 6. In particular, the use of “step of” in the claims herein is not intended to invoke the provisions of 35 U.S.C. § 112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A disposable non-metallic double-ended dental scaler comprising a handle and two dental picks projecting axially from each end of the handle, the dental pick having a stem, an intermediate section projecting from the stem and terminating in a tip, the tip maintaining an angle from the intermediate section and comprising a resilient, non-metallic material, wherein the tips are in different planes and equally and oppositely angled with respect to the intermediate sections connected thereto, one of the tips being angled to allow for use on right side of inter-proximal spaces between adjacent teeth and the other being angled to allow for use on left side of inter-proximal spaces between adjacent teeth.

2. The dental scaler of claim 1, wherein the intermediate section comprises an arced structure.

3. The dental scaler of claim 1, wherein the dental scaler is made of plastic.

4. A disposable non-metallic double-ended dental scaler comprising a handle and two dental picks projecting axially from the ends of the handle, the dental pick having a stem, a first substantially linear segment projecting at an angle from the stem and away from the handle, a second substantially linear segment projecting at an angle from the first linear segment and away from the handle, and a tip projecting at an angle from the second linear segment, the tips being resilient, in different planes and equally and oppositely angled with respect to the second linear segments connected thereto, one of the tips being angled to allow for use on right side of inter-proximal spaces between adjacent teeth while the other tip on the opposite end of the handle being angled to allow for use on left side of inter-proximal spaces between adjacent teeth.

5. A disposable non-metallic double-ended dental scaler, comprising a handle and two dental picks projecting axially from either ends of the handle, the dental pick having a stem, an arced zone projecting from the stem, and a tip projecting at an angle from the arced zone, the tips being resilient, in different planes and equally and oppositely angled with respect to the arced zones connected thereto, one of the tips being angled to allow for use on right side of inter-proximal spaces between adjacent teeth while the other tip on the opposite end of the handle being angled to allow for use on left side of inter-proximal spaces between adjacent teeth.
